(19) United States
(12) Patent Application Publication
(10) Pub. No.: US 2024/0227772 A9
(43) Pub. Date: Jul. 11, 2024

(54) DEVICE AND METHOD FOR THE MODEL-BASED PREDICTED CONTROL OF A COMPONENT OF A VEHICLE

(71) Applicant: ZF Friedrichshafen AG, Friedrichshafen (DE)

(72) Inventor: Timon Busse, Munich (DE)

(73) Assignee: ZF Friedrichshafen AG, Friedrichshafen (DE)

(21) Appl. No.: 18/548,315

(22) PCT Filed: Nov. 30, 2021
(86) PCT No.: PCT/EP2021/083455

§ 371 Date: Aug. 29, 2023

(30) Foreign Application Priority Data
Mar. 15, 2021 (DE) 10 2021 202 468.8

(51) Int. Cl. B60W 20/11; B60W 10/26; B60W 50/00

(52) U.S. Cl. CPC B60W 20/11; B60W 10/26; B60W 50/0097; B60W 2300/10; B60W 2556/00; B60W 2710/246

(57) ABSTRACT

A device for model predictive control of a vehicle component includes a first input receiving sensor data, a second input receiving data regarding a topology in a vehicle's environment, a control unit for executing a predictive algorithm for generating a control value for the component, an output for outputting the control value, wherein the predictive algorithm comprises a vehicle model including a battery model, wherein the sensor and topology data are processed in the predictive algorithm, the predictive algorithm also including an optimization function including energy consumption predicted by the battery model, travel time predicted by the vehicle model, information regarding a charging station along a route of the vehicle predicted by the vehicle model in a prediction horizon, and information regarding the predicted charging state of the battery at the charging station, and the predictive algorithm generates the control value through minimization in the optimization function.

The present invention relates to a device, as well as a system and method for model-based predicted control of a component in a vehicle that has a battery and an electric motor.

Modern vehicles (automobiles, vans, trucks, motorcycles, etc.) have numerous systems with which the driver acquires information, and with which individual functions in the vehicle are partially or fully automated. Sensors are used to detect a vehicle's environment, with which a model of the environment is then generated, which in turn is integrated in an existing vehicle model. As a result of the advances made in the field of autonomous and partially autonomous vehicles, the effects and scope of such advanced driver assistance systems (ADAS) are continuously increasing. In particular with vehicles that have electric drive motors, the model predictive control (MPC) methods are also used in motor vehicles in the fields of trajectory control and motor control in particular. By way of example, energy consumption can be optimized with predictive control.

An optimization and energy management strategy is disclosed in EP2610836 A1, with which costs are minimized on the basis of a prediction horizon and other environment data. This makes use of an artificial neural network in the vehicle. A model of the driver is also obtained, with which a probable driving speed profile is generated. EP1256476 discloses a strategy for reducing energy consumption in order to increase the travel range of the vehicle. This makes use of navigation system data, including the current vehicle location, street maps, and geography, containing data regarding the date and time, changes in elevation, speed limits, congestion, traffic monitoring, and driving patterns of the driver.

The main factors affecting energy consumption when operating a motor vehicle are the driver and the driver's style of driving. Even with conventional cruise control, energy consumption is not taken into account. Known predictive driving strategies are typically control-based and do not always deliver optimal results. Optimization-based strategies also use a lot of computing power and have only been used in offline solutions, or been solved with dynamic programming.

With battery operated electric vehicles, the other components that use electricity also play a decisive role in energy consumption and therefore impact the travel range of the vehicle. These components are not sufficiently taken into account in energy management systems, if they are taken into account at all.

Based on this, the object of the present invention is to create a system with improved model predictive control in which improved energy management is used to adapt energy consumption to given constraints.

To solve these problems, the invention involves a device for model predictive control of a component in a vehicle that has a battery and an electric motor, comprising:
a first input interface for receiving sensor data from a vehicle sensor;
a second input interface for receiving data regarding the topology of the vehicle's environment;
a control unit that executes a predictive algorithm for generating a control value for the component in the vehicle; and
an output interface for outputting the control value for the component in the vehicle that is determined in the control unit;
wherein
the predictive algorithm comprises a vehicle model and an optimization function;
the vehicle model comprises a model of the battery, and sensor data and topology data are processed in the predictive algorithm;
the optimization function comprises power consumption and travel time, in which the power consumption is predicted using the battery model and the travel time is predicted using the vehicle model;
the optimization function comprises data regarding charging stations on the route taken by the vehicle in a prediction horizon, and data regarding the charging state of the battery when the vehicle reaches the charging station; and
the predictive algorithm generates the control value through minimization in the optimization function.

The present invention also relates to a system for model predictive control of a component in a vehicle that has a battery and an electric motor, comprising:
a device of the type described above, a sensor for acquiring sensor data regarding a vehicle's environment, and a topology unit for acquiring topology data.

The invention also relates to a corresponding method, vehicle, and computer program containing programming code with which the steps of the method are carried out on a computer, as well as a memory in which a computer program is stored that executes the method described herein on a computer.

Preferred embodiments of the invention are described in the dependent claims. It is understood that the above features and those described below can be used not only in the given combinations but also in other combinations, or in and of themselves, without abandoning the framework of the present invention. In particular, the method and computer program can be executed with the embodiments of the device and the system described in the dependent claims.

The device according to the invention uses a control unit in which a predictive algorithm is carried out to generate a control value for a vehicle component. The predictive algorithm is based on a vehicle model and an optimization function. The vehicle model can comprise a dynamics model of the longitudinal drive for the vehicle, as well as models of individual components of the vehicle. By way of example, the vehicle model contains a battery model in which the battery management and battery are depicted. The vehicle model also contains data and parameters for other components such as the air conditioner, brakes, or various cameras. It also contains the navigation system and the electronic maps stored therein, as well as data regarding the topology of the vehicle's environment, e.g. street maps and other information. The battery model comprises the battery itself as well as temperature control for the battery, and models depicting the charging cycle and energy output of the battery based on the battery temperature, for example. The battery model can contain a cooling pump or temperature control system.

The predictive algorithm executed in the control unit is based on an MPC solver or MPC algorithm. The predictive algorithm can be used to plan how electricity can be used efficiently for the overall energy efficiency of the vehicle. Both energy efficient as well as more comfortable actuator combinations can be used in the predictive algorithm to determine the amount of freedom in planning the energy consumption strategy. The predicted and planned degrees of freedom can be sent to a so-called target generator, which can then control the individual actuators, such as those for the drive train or other components and actuators in the vehicle.

Various components relating to energy efficiency are used in modern vehicles that are not only part of the drive train. It is possible to optimize energy consumption and energy management, including the determination of charging phases for the battery in which the travel time and energy consumption are taken into account, using the predictive algorithm in the control unit. An optimal driving efficiency can be determined for every driving situation under the given constraints and limitations therewith, with which an energy-efficient manner of driving can be established. The fundamental system model or vehicle model that is used describes the overall behavior of the vehicle. The predictive algorithm makes use of a target function or optimization function, which can also be referred to as a cost function. This describes an optimization problem and determines which state variables are to be optimized.

The optimization relates to a minimization in the optimization function. The optimization function determines which state variables are to be minimized. The relevant variables here are the vehicle's energy consumption and travel time. Energy consumption and travel time can be optimized on the basis of the route that is to be taken and a prediction horizon. This can take speed limits and/or driving power into account, as well as the general condition of the vehicle. In addition to optimizing the energy consumption and travel time, the optimization function also contains data regarding a charging station along the route predicted with the vehicle model in the prediction horizon. This takes the location of the next charging station along the predicted route into account. The optimization function also contains information regarding the charging state of the battery at the charging station on the predicted route. A control value specific to the application can be determined from these values for a component in the vehicle.

If the vehicle is a bus, for example, bus stops along the route can also be taken into account in the device according to the invention. The optimization function can then be adjusted accordingly, incorporating arrival times at the bus stops in the optimization function. Some of these bus stops may also have charging stations that can be included in the optimization function.

The vehicle component can be a component in the vehicle drive train. The optimization function can reference a longitudinal dynamics model for the vehicle for this, which can also contain a loss model for the vehicle. Various vehicle parameters and drive train losses can be accounted for, which can be stored in the model in the operating parameters or motor characteristics. These values can be calculated or simulated. Loss models like these are already in use.

To determine the necessary inputs for the predictive algorithm and optimization function, the device according to the invention accesses sensor data from one or more sensors in the vehicle as well as data relating to the topology of the vehicle's environment. This data is sent to the device through first and second interfaces. The sensor data can be obtained with different optical sensors, for example. These can be radar sensors, lidar sensors, or camera sensors. These can map out the immediate environment of the vehicle. GNSS sensors or GPS sensors can be used to determine the location of the vehicle. This can be used with the topology data from a topology unit to predict a route for the vehicle within the prediction horizon. Inclines and the like, as well as road grids can be accounted for with regard to the topology data and the current position of the vehicle.

The amount of electricity provided by the battery within the prediction horizon and the travel time to a destination or the prediction horizon predicted with the vehicle model are taken into account in the prior art. By expanding the optimization function and taking into account data regarding the distance to a charging station along the predicted route, as well as the predicted charging state upon reaching the charging station, a more efficient driving strategy can be obtained. The optimization can be adjusted to a driver's preferences and improved through the selection and weighting of the constraints. In particular, it is possible to take into account the energy consumption in relation to the distance to a charging station or the predicted charging state of the battery at the charging station. By way of example, a particularly optimal operating point for the motor can be set on the basis of the input values. This makes it possible to determine the optimal speed of the vehicle.

The components of the vehicle controlled by the device can also be outside the drive train. It may be necessary to control individual components on the basis of the vehicle model to obtain an energy-efficient control of the vehicle. By way of example, the use of some components can be reduced on the basis of information regarding the topology or environment of the vehicle. It would be conceivable to reduce the power consumption of certain components at an incline expected within the prediction horizon in order to make optimal use of the available electricity. If weather models are taken into account in the vehicle model, the energy consumption and speed of the vehicle can be adjusted to the weather conditions.

One possibility is closing electric windows in order to reduce the wind resistance if the predicted charging state of the battery at the charging station falls below a predefined limit, or if the information regarding the charging station indicates that it may not be possible to charge the battery, or the charging thereof is inconvenient. In this case, it may be possible to drive to another charging station, which would require a more efficient operation of the vehicle to be able to reach the alternative charging station.

The device has the advantage of planning the charging procedures as well as the energy consumption, and adjusting and coordinating the charging of the battery thereto.

In a preferred embodiment, the energy, travel time, information regarding the charging station, and/or the charging state of the battery at the charging station are taken into account as weighted variables in the optimization function. Each of the individual features in the optimization function has its own weighting factor, each of which can be independent from the others. The optimization function therefore has numerous weighted variables. This has the advantage that the individual parameters can be weighted differently, depending on the existing constraints or other limits. By way of example, it is also possible to sanction individual parameters under certain constraints.

The optimization function preferably contains data regarding a point on the route categorized as a stop. This point is within the prediction horizon on the route predicted by the vehicle model. This stop is a point that the vehicle must pass where the vehicle is likely to stop. If the vehicle is a bus, for example, this stop is a point where the bus normally stops, at least if one of the passengers intends to deboard, or another passenger want to board. Other places on the route can also be categorized as stops. These can be scenic views where it may be considered worthwhile to stop, for example. Intersections with stoplights can also be categorized as stops.

This data regarding a point categorized as a stop is included in the optimization function as a weighted variable. This means that the optimization function contains another variable with another weighting factor that contributes to individual weighting.

In another preferred embodiment, the optimization function also contains arrival times for the various stopping points, indicating when the vehicle is expected to arrive at these stopping points. This makes it possible to determine arrival times and create schedules for public buses on the basis of model predictive control. Depending on the desired or expected arrival times, the optimization function can obtain short term results, or for a specific time period or specific route, that differ from those it would obtain if these were not taken into account.

The optimization function in the predictive algorithm also contains, in addition to the information regarding the location of the charging station, a variable with an occupancy parameter for the charging station, which takes the occupancy of the charging station into account. If a charging station is occasionally used by other vehicles, and therefore not always available to the vehicle in question, this can also be taken into account. This occupancy parameter can also comprise a time period in which the charging point is likely to be occupied. The driving algorithm or speed trajectory can be adjusted accordingly, such that the charging station is reached when it is unoccupied. The charging procedure can then start immediately upon reaching the charging station.

In a preferred embodiment, the control value determined by the predictive algorithm in the control unit is a motor control value for the electric motor in the vehicle. The electric motor in the drive train can therefore be controlled by the device according to the invention. In this case, the vehicle model can contain a longitudinal dynamics model for the drive train, such that it can take a speed trajectory into account with which the motor can be controlled directly.

In another preferred embodiment, the control value generated by the predictive algorithm in the control unit can be a pump control value. The pump control value is used to control a battery cooling pump with which the battery is cooled in accordance with the battery model. The battery cooling pump is therefore also part of the battery model and is taken into account in the vehicle model. By way of example, it may make sense to operate the battery cooling pump in an energy saving manner. If the battery is cold, for example, and needs to be warmed up in order to operate at the optimal level, in some circumstances it may still make sense to not heat the battery. This may be the case if there is a long and steep incline is coming up in the next few kilometers along the route that will require a good deal of electricity. This will heat up the battery, which will then require subsequent cooling. By omitting the preheating the battery may not be operated at the optimal level for a short distance before the incline. Nevertheless, the overall energy consumption is significantly more efficient if the battery is not necessarily heated for a short distance, only to be immediately cooled thereafter. Situations such as these can advantageously be taken into account with this preferred embodiment of the present invention.

In another preferred embodiment, the control value generated by the predictive algorithm in the control unit is an air conditioning control value. The air conditioning control value is used to control the air conditioner in the vehicle. It may be advantageous to shut off the air conditioner if a great deal of energy is needed from the battery for another component, and/or the battery is nearly empty. By way of example, this may be the case on inclines or if the vehicle is transporting or towing heavy loads.

The system for model predictive control of a component in a vehicle that has a battery and an electric motor comprises the above device as well as at least one sensor for acquiring sensor data containing information regarding the vehicle's environment. The system also contains a topology unit for acquiring data regarding topology. The sensors can be optical sensors such as radar sensors, lidar sensors or camera sensors, which are typically installed in vehicles. Other sensors can be position sensors with which the location of the vehicle can be determined. This information is combined with data from an electric map to determine the position of the vehicle in a given environment. The topology data from the topology unit is also necessary for acquiring information regarding the route, e.g. inclines, slopes, curves, the type of road or street, and data regarding speed limits or other constraints. Information regarding the immediate environment is also obtained from the optical sensors, in addition to the general data regarding the vehicle's environment, e.g. regarding other vehicles, people, or objects.

Another aspect of the invention relates to a vehicle that has a battery and an electric motor. The vehicle contains the system described above and a component for which the system generates a control value, which is controlled on the basis of a model and predictively.

In a preferred embodiment, the vehicle is a bus, particularly a public transit bus. The optimization function contains information regarding bus stops along the predicted route within a prediction horizon. The optimization function can also contain a variable that takes an arrival time at the bus stop into account.

In addition to the above constraints, the constraints and parameters used in the prior art can also be taken into account. These include speed limits for the vehicle dictated by the type of street or where it is located, e.g. an urban street. This also includes speed limits that change when the vehicle exits a city and is travelling on a rural road. Other limits may be torque limits that restrict the vehicle acceleration, which could otherwise result in discomfort for the vehicle passengers.

In addition to these constraints, there are others that are fulfilled in the present invention, which take stops on the predict route of the vehicle into account, for example. This is important if the vehicle is a bus, or a public transit vehicle, for example. Arrival times can be taken into account as further parameters in the optimization function or as constraints, and can also be incorporated in the optimization function.

In addition to the battery model, the vehicle model can also include a driving dynamics model or a longitudinal dynamics model of a motor vehicle. By way of example, a driving dynamics model of a motor vehicle can contain a traction force exerted on the wheels of the vehicle, a rolling resistance force, which takes the effects of the deformation of the tires when rolling and the load to the wheels into account, an incline resistance, which describes the longitudinal component of gravity and is a function of the slope of the roadway, and an air resistance of the vehicle. The vehicle model can be regarded mathematically as a temporal derivation of the speed, in which the sum of the forces is related to the equivalent mass of the vehicle. The equivalent mass of the vehicle can comprise the inertia of the rotating parts of the drive train. The optimization function is a cost function that comprises weighting factors for the energy consumption of the battery, the energy consumption of the battery, the route, the driving force, the time, information regarding a charging station and the charging state of the battery at the charging station and at the start of the prediction horizon, as well as various weighting factors for the individual variables that can be added together, for example. Current state variables can be measured, from which data can be acquired and fed into the predictive algorithm. By way of example, route data from an electronic map, the topology unit or a navigation system can be updated cyclically for a prediction horizon for the motor vehicle. The prediction horizon is preferably a range of at least 100 meters, more preferably at least 500 meters, particularly preferably at least 1 kilometer. Route data or topology data can comprise incline information, curve information, speed limits, etc. The predicted route is a route predicted within the prediction horizon, obtained from the vehicle model. A charging station is a place where there is an apparatus for charging an electric vehicle. This can be an electric vehicle charging station, for example. These can also be inductive charging means, with which the electric vehicle can be recharged using a current collector. A bus is a vehicle for transporting people, in particular along a defined route that can be stored in the electronic map or in the vehicle model. In particular with public transit buses, the route is basically established. The vehicle can still make a detour from the defined and established route, however. Information regarding the route can be taken into account and processed in the vehicle model and/or the optimization function.

The invention shall be described and explained in greater detail below on the basis of selected exemplary embodiments, in reference to the drawings. Therein:

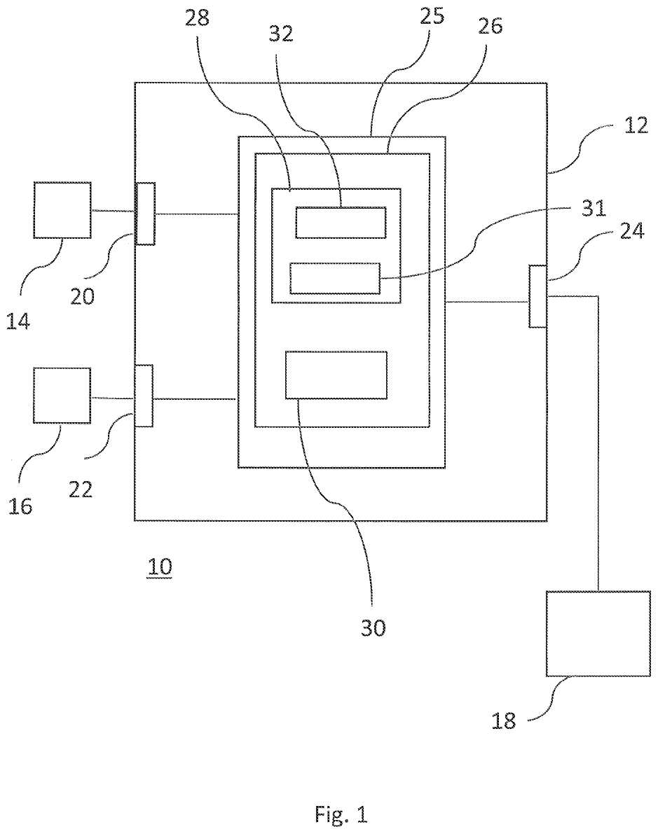

FIG. 1 shows a schematic illustration of the system according to one aspect of the present invention;

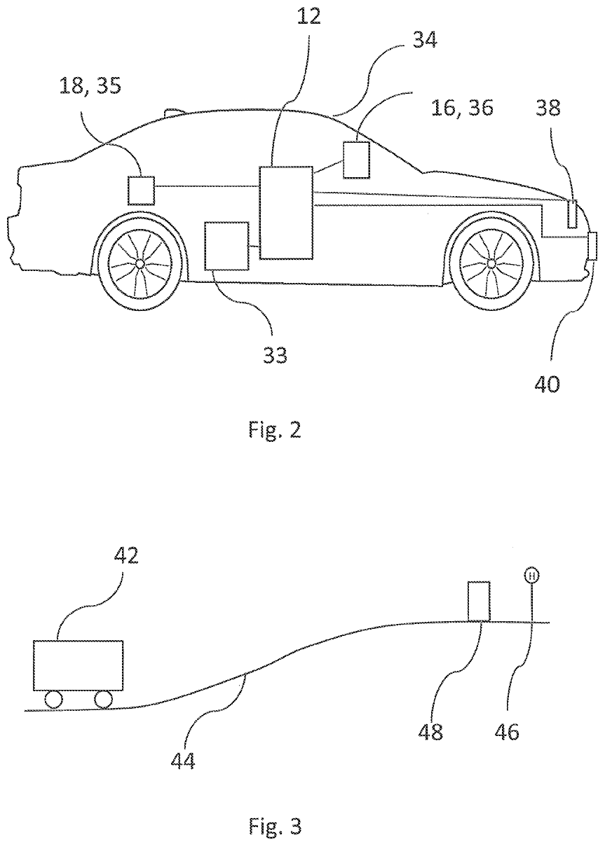

FIG. 2 shows a schematic illustration of a vehicle that has the system;

FIG. 3 shows a schematic illustration of a driving situation; and

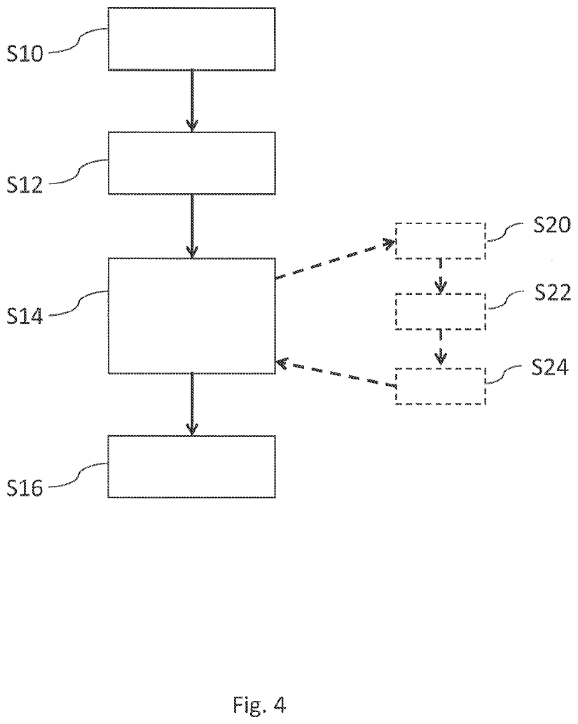

FIG. 4 shows a schematic illustration of the method according to the invention.

FIG. 1 shows a system 10 with a device 12 according to the invention, a sensor 14, and a topology unit 16. FIG. 1 also shows a component 18 that is connected to the system 10 and controlled therewith.

The device 12 comprises a first input interface 20, which is connected to the sensor 14 and receives sensor data from the sensor 14. The device 12 has a second input interface 22 for receiving data regarding the topology of the vehicle's environment. The second input interface 22 is connected to the topology unit 16 and receives data from the topology unit 16. A control unit 25 in the device 12 contains a predictive algorithm 26 that generates a control value for a component, e.g. the component 18 connected to the system. An output interface 24 outputs the control value for the component 18 generated in the device 12. This control value is sent from the output interface 24 to the component 18.

The predictive algorithm 26 in the device 12 processes the sensor data from the first input interface 20 and the data from the second input interface 22. The predictive algorithm 26 comprises a vehicle model 28, and an optimization function 30, which takes the various parameters of a vehicle and the parameters provided by the vehicle model 28 into account. The optimization function 30 is preferably a cost function. The minimization in the optimization function 30 is obtained with a quadratic function or some other minimizing function. These optimization functions, or cost functions, are basically known from the prior art, as is minimization in an optimization function.

The vehicle model 28 contains a battery model 32 with which a battery in a vehicle, including the energy management of the battery and a model of the cooling pump or a temperature control unit for the battery, can be depicted. The vehicle model 28 can also contain a driving dynamics model 31, which takes the drive train and its components into account, for example.

By way of example, the optimization function 30 can include power consumption and vehicle travel time, in which the power consumption is preferably predicted by the battery model 32 and the travel time is predicted by the vehicle model 28 or driving dynamics model 31. The optimization function 30 can also contain information regarding a charging station on the route predicted with the vehicle model 28 in a prediction horizon, as well as information regarding the predicted charging state of the battery at the charging station along the route. The predictive algorithm 26 processes the data and predicted values that it acquires from the vehicle model 28, and generates a control value for a component 18 in a vehicle through minimization in the optimization function 30.

FIG. 2 shows a schematic illustration of a vehicle 34, which contains the device 12, and a topology unit 16 that functions as a navigation system 36 for the vehicle 34 and provides data regarding topology. This data can come from the electronic map in the navigation system 36. The vehicle 34 has numerous sensors 14, comprising a radar sensor 38 and a lidar sensor 40 in this case. The two sensors provide data regarding the immediate environment of the vehicle, e.g. sensor data regarding other vehicles in the vicinity of the vehicle.

The device 12 controls a component 18 in the vehicle 34, which is an electric motor 42 in the drive train in this case. The electric motor 42 drives one of the wheels on the vehicle 34. A battery 33 supplies the necessary energy. It is depicted by the battery model 32.

FIG. 3 shows a schematic illustration of a traffic situation in which the vehicle 34 is a bus 42. The bus 42 travels along a route 44 that contains a stop. The stop is a bus stop 46 in a public transportation system. The vehicle 34 can be recharged at the stop 46, and thus contains a charging station 48. For purposes of energy management for the bus 42, the charging state of the battery 33 in the vehicle at the stop 46 can be predicted.

Planned arrival times at the stop 46 can also be taken into account when optimizing the energy consumption by the vehicle and/or optimizing the range of the vehicle. These predefined arrival times can be compared and coordinated to arrival times predicted with the vehicle model. This can be achieved by weighting the predicted arrival time accordingly in the optimization function.

It is also possible to shut off individual components in the vehicle in order to conserve energy. The conserved energy is then available for the driving dynamics model and can be used by the motor to temporarily obtain a higher torque therefrom, and therefore accelerate the vehicle, in order to arrive at the stop 46 according to the schedule. The speed trajectory that is determined is then adjusted on the basis of the optimization function.

It is also possible for there to be a charging station along the route that is not a scheduled bus stop 46. The charging station may be occupied by other vehicles, such that it is not possible to recharge the battery upon arrival. In this case, the vehicle can either wait, or it can pass by the charging station 48 and drive to another charging station. The occupancy of the charging station can be taken into account in the optimization function. This is preferably obtained with a weighting factor, which can sanction an occupied charging station 48. It is also possible to ignore an occupied charging station in the optimization function.

Similar scenarios and other constraints can be defined as soft constraints or a hard constraints, and stored in the vehicle model. By way of example, the arrival time can be a hard constraint for maintaining a predefined schedule. This constraint is then given priority and must be satisfied. This may require an increase energy consumption in order to arrive at the stop 46 on time. It is also possible to shut off certain components in the vehicle in order to conserve energy. This results in an advantageous and advanced energy management.

FIG. 4 shows a schematic flow chart for the method according to the invention for model predictive control of a component 18 in a vehicle 34 that contains a battery and an electric motor. In a first step S10, sensor data is received from a sensor 14 in the vehicle 34. In a second step S12, data is received regarding the topology of the environment of the vehicle 34. The predictive algorithm is executed in step S14, to generate a control value for a component 18 in the vehicle 34. In an output step S16, the control value for the component 18 is output to the component 18. The control value is determined in the control unit in step S14.

In a preferred embodiment of the method according to the invention, numerous sub-steps are carried out in step S14, in which the predictive algorithm is executed. These sub-steps are optional and therefore indicated by a broken line in FIG. 4. Step S20 can thus comprise predicting energy consumption. Step S22 can comprise predicting a travel time on the basis of the vehicle model. Step S24 can comprise executing an optimization function in which the predicted energy consumption and travel time, as well as information regarding a charging state along the predicted route for the vehicle 34 and information regarding a predicted charging state of the battery 33 at the charging state 48, are taken into account. A minimization is preferably carried out in the optimization function in this step, to thus obtain the control value for the component 18.

The invention has been comprehensively described and explained in reference to the drawings. The descriptions and explanations are to be regarded as exemplary, and not limiting. The invention is not limited to the disclosed embodiments. Other embodiments or variations can be derived by the person skilled in the art through the use of the present invention and through a precise analysis of the drawings, the disclosure, and the following claims.

The words, “comprising” and “with” in the claims do not exclude the presence of other elements or steps. Indefinite articles, “a” or “an” do not exclude pluralities. A single element or single unit can execute the functions of numerous units specified in the claims. An element, unit, interface, device, or system can be partially or entirely formed by hardware and/or software. Simply specifying certain measures in numerous dependent claims is not to be understood to mean that a combination of these measures cannot also be used advantageously. A computer program can be stored/distributed on non-volatile data carrier, e.g. an optical storage medium or a solid state drive (SSD). A computer program can be distributed with hardware and/or as a part of a hardware, e.g. through the internet or hardwired or wireless communication systems. Reference symbols in the claims are not to be regarded as limiting.

### REFERENCE SYMBOLS

10 system
12 device
14 sensor
16 topology unit
18 component
20 first input interface
22 second input interface
24 output interface
25 control unit
26 predictive algorithm
28 vehicle model
30 optimization function
31 vehicle dynamics model
32 battery model
33 battery
34 vehicle
35 electric motor
36 navigation system
38 radar sensor
40 lidar sensor
42 bus
44 route
46 stop
48 charging station

1-15. (canceled)

16. A device for model predictive control of a component in a vehicle that has a battery and an electric motor, the device comprising:
a first input interface configured to receive sensor data from a sensor in the vehicle;
a second input interface configured to receive data regarding a topology of the vehicle's environment;
a control unit configured to execute a predictive algorithm to generate a control value for the component in the vehicle;
an output interface configured to output the control value for the component in the vehicle generated in the control unit,
wherein the predictive algorithm comprises a vehicle model and an optimization function,
wherein the vehicle model comprises a battery model and, and wherein the sensor data and data regarding the topology are processed in the predictive algorithm;
wherein the optimization function comprises energy consumption and travel time,
wherein the energy consumption is predicted by the battery model and the travel time is predicted by the vehicle model;
the optimization function comprises information regarding a charging station along a route for the vehicle predicted by the vehicle model in a prediction horizon, and information regarding the predicted charging state of the battery at the charging station; and
the predictive algorithm generates the control value through minimization in the optimization function.

17. The device according to claim 16, wherein the optimization function comprises the energy consumption, travel time, information regarding the charging station, and/or the charging state as weighted variables.

18. The device according to claim 16, wherein the optimization function comprises information regarding a point categorized as a stop on the route of the vehicle in the prediction horizon predicted by the vehicle model, wherein the information regarding the stop is included in the optimization function as a weighted variable.

19. The device according to claim 18, wherein the optimization function includes a variable that takes an arrival time at the stop into account.

20. The device according to claim 16, wherein the optimization function contains an occupancy parameter that accounts for an occupancy of the charging station.

21. The device according to claim 16, wherein the control value generated by the predictive algorithm in the control unit is a control value for the electric motor in the vehicle.

22. The device according to claim 16, wherein the control value generated by the predictive algorithm is a pump control value for controlling a cooling pump configured to control a temperature of the battery.

23. The device according to claim 16, wherein the control value generated by the predictive algorithm is an air conditioning control value for controlling an air conditioner in the vehicle.

24. A system, comprising
the device according to claim 16;
the sensor configured to acquire the sensor data with information regarding the vehicle's environment; and
a topology device configured to acquire the data regarding the topology.

25. The system according to claim 24, wherein the sensor is an optical sensor, a radar sensor, a lidar sensor, a camera, a Global Navigation Satellite System (GNSS) sensor, or a Global Positioning System (GPS) sensor.

26. A vehicle comprising:
a battery; an electric motor; and
the system according to claim 24; and
a component for which the control value is generated by the system.

27. The vehicle according to claim 26,
wherein the vehicle is a bus,
wherein the optimization function comprises information regarding a point categorized as a stop on the route of the vehicle in a prediction horizon predicted by the vehicle model, and
wherein the optimization function includes a variable that takes the arrival time at the stop into account.

28. A method for model predictive control of a component in a vehicle that has a battery and an electric motor, the comprising:
receiving sensor data form a sensor in the vehicle;
receiving data regarding a topology in the vehicle's environment;
executing a predictive algorithm to generate a control value for the component,
wherein the predictive algorithm comprises a vehicle model and an optimization function,
the vehicle model comprises a battery model and the sensor data and data regarding topology are processed in the predictive algorithm,
the optimization function comprises energy consumption and travel time, wherein the energy consumption is predicted by the battery model and the travel time is predicted by the vehicle model,
the optimization function comprises information regarding a charging station along the route of the vehicle in a prediction horizon predicted by the vehicle model, and information regarding the predicted charging state of the battery at the charging station, and
wherein executing the predictive algorithm comprises generating, with the predictive model, the control value through minimization in the optimization function; and
outputting the control value for the component.

29. The method according to claim 28, wherein the optimization function comprises information regarding a point categorized as a stop on the route of the vehicle predicted by the vehicle model in a prediction horizon.

30. The method according to claim 28, wherein the optimization function comprises the energy consumption, travel time, information regarding the charging station, and/or the charging state as weighted variables.

31. The method according to claim 28, wherein the optimization function includes a variable that takes an arrival time at the stop into account.

32. The method according to claim 28, wherein the optimization function contains an occupancy parameter that accounts for an occupancy of the charging station.

33. The method according to claim 28, wherein the control value generated by the predictive algorithm in the control unit is a control value for the electric motor in the vehicle.

34. The method according to claim 28, wherein the control value generated by the predictive algorithm is a pump control value for controlling a cooling pump configured to control a temperature of the battery.

35. A non-transitory computer readable medium having stored thereon programming code that, when executed by a computing device, cause the computing device to perform a method comprising:
receiving sensor data form a sensor in a vehicle;
receiving data regarding a topology in the vehicle's environment;
executing a predictive algorithm to generate a control value for a component of the vehicle,
wherein the predictive algorithm comprises a vehicle model and an optimization function,
the vehicle model comprises a battery model, wherein the sensor data and data regarding the topology are processed in the predictive algorithm,
the optimization function comprises energy consumption and travel time, wherein the energy consumption is predicted by the battery model and the travel time is predicted by the vehicle model,
the optimization function comprises information regarding a charging station along the route of the vehicle in a prediction horizon predicted by the vehicle model, and information regarding the predicted charging state of the battery at the charging station, and
wherein executing the predictive algorithm comprises generating, with the predictive model, the control value through minimization in the optimization function; and
outputting the control value for the component.
